(19) United States
(12) Patent Application Publication
(10) Pub. No.: US 2026/0171119 A1
(43) Pub. Date: Jun. 18, 2026

(54) GESTURE DIRECTED REAL-TIME VIDEO EDITING

(71) Applicant: International Business Machines Corporation, Armonk, NY (US)

(72) Inventors: Rohit Tripathi, Satna (IN); Adhish Kapoor, Ludhiana (IN); Dishant J. Doriwala, Hyderabad (IN); Neha Jain, Ludhiana (IN)

(21) Appl. No.: 18/986,555

(22) Filed: Dec. 18, 2024

(51) Int. Cl. G11B 27/031; G06F 3/01

(52) U.S. Cl. CPC G11B 27/031; G06F 3/017

(57) ABSTRACT

A method according to one approach, includes: receiving a video stream captured by a camera, the video stream including images of a presenter and presentation material.

Movements of the presenter in the video stream are monitored and in response to detecting the presenter making a predetermined gesture, the video stream is edited in real-time. The video stream is edited such that a portion of the presentation material which corresponds to when the presenter made the predetermined gesture is modified in a manner that is correlated with the predetermined gesture.

### BACKGROUND

The present invention relates to video editing, and more specifically, this invention relates to real-time video editing.

Presentations and other types of content are often recorded in videos and distributed later to a much wider audience than a live or originally intended audience. Accordingly, edits are made to the video after the presentation is over in order to make it suitable for wider distribution. In such conventional cases, video is recorded during the presentation and later processed by a trained personnel using video processing software to edit the video based on input given by the presenter or another source.

Conventional products thereby require the presenter to either edit a recorded video themselves after concluding a presentation, or synchronize with a trained editing personnel to provide the input for editing the video after it has been recorded. These options involve post processing and manual editing of videos. A need for a more efficient process of editing recorded content thereby exists.

### SUMMARY

A method according to one approach, includes: receiving a video stream captured by a camera, the video stream including images of a presenter and presentation material. Movements of the presenter in the video stream are monitored and in response to detecting the presenter making a predetermined gesture, the video stream is edited in real-time. The video stream is edited such that a portion of the presentation material which corresponds to when the presenter made the predetermined gesture is modified in a manner that is correlated with the predetermined gesture.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system further includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for editing videos in real-time (e.g., before being stored to memory) based on inputs received from subjects in the videos. Approaches herein are thereby able to selectively edit videos as they are being recorded, thereby avoiding any post processing or editing of the video after it has been stored in memory. This also allows for videos to be edited in (e.g., by) a same device that records the video, thereby eliminating any additional third party editing software. Approaches are also able to provide an edited version of the video immediately following the live event, thereby reducing latency as a whole, e.g., as will be described in further detail below.

In one general approach, a method includes: receiving a video stream captured by a camera, the video stream including images of a presenter and presentation material. Movements of the presenter in the video stream are monitored and in response to detecting the presenter making a predetermined gesture, the video stream is edited in real-time. The video stream is edited such that a portion of the presentation material which corresponds to when the presenter made the predetermined gesture is modified in a manner that is correlated with the predetermined gesture.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system further includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved video editing code at block 150 for editing videos in real-time (e.g., before being stored to memory) based on inputs received from subjects in the videos. Approaches herein are thereby able to selectively edit videos as they are being recorded, thereby avoiding any post processing or editing of the video after it has been stored in memory. This also allows for videos to be edited in (e.g., by) a same device that records the video, thereby eliminating any additional third party editing software. Approaches are also able to provide an edited version of the video immediately following the live event, thereby reducing latency as a whole, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

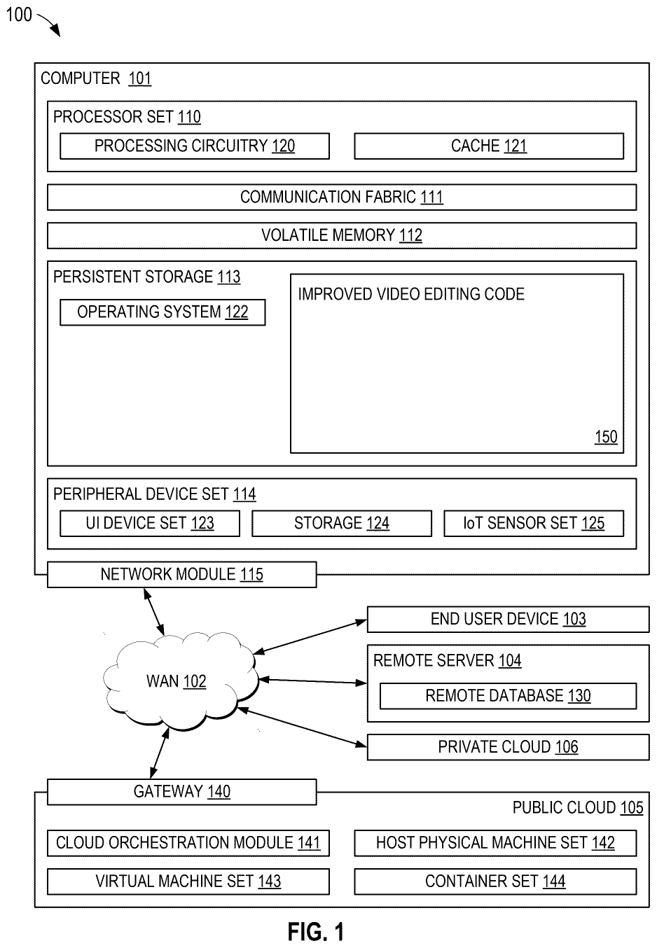

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, presentations and other types of content are often recorded and distributed later to a much wider audience than a live audience. This often results in edits being made to the video after the presentation is over in order to make it suitable for wider distribution. In such conventional cases, video is recorded during the presentation and later processed by a trained personnel using video processing software to edit the video based on input given by the presenter or another source.

Conventional products thereby require the presenter to either edit a recorded video themselves after concluding a presentation, or synchronize with a trained editing personnel to provide the input for editing the video after it has been recorded. These options are cumbersome and time consuming, as they involve post processing manual editing of video, introducing significant extra cost. A need for a more efficient process of editing recorded content thereby exists.

In sharp contrast to these conventional shortcomings, approaches herein are desirably able to edit videos in real-time (e.g., before being stored to memory) based on inputs received from subjects in the videos. Approaches herein are thereby able to selectively edit videos as they are being recorded. In some approaches, this is achieved by editing the video in real-time as it is captured by the camera and analyzed in view of the presenter's gestures, thereby avoiding any post processing or editing of the video after it has been stored in memory. In other approaches, a video may be edited immediately after the presentation has concluded, e.g., as a form of immediate post processing. In such approaches, the edits are recorded while the video stream is ongoing, but executed in direct response to the video stream ending. Because the edit gestures have already been recorded (e.g., been embedded in the captured video), it typically only takes approaches herein a few milliseconds of post processing to edit the video. This also allows for videos to be edited in (e.g., by) a same device that records the video, thereby eliminating any additional third party editing software. Approaches are also able to provide an edited version of the video immediately following the live event, thereby reducing latency as a whole. The edits may also be directed by a presenter in the video, allowing for the final edited video to only present desired content. For example, editing confidential information out of the images and/or audio in a video stream in real-time avoids storing confidential information in memory even temporarily, e.g., as will be described in further detail below.

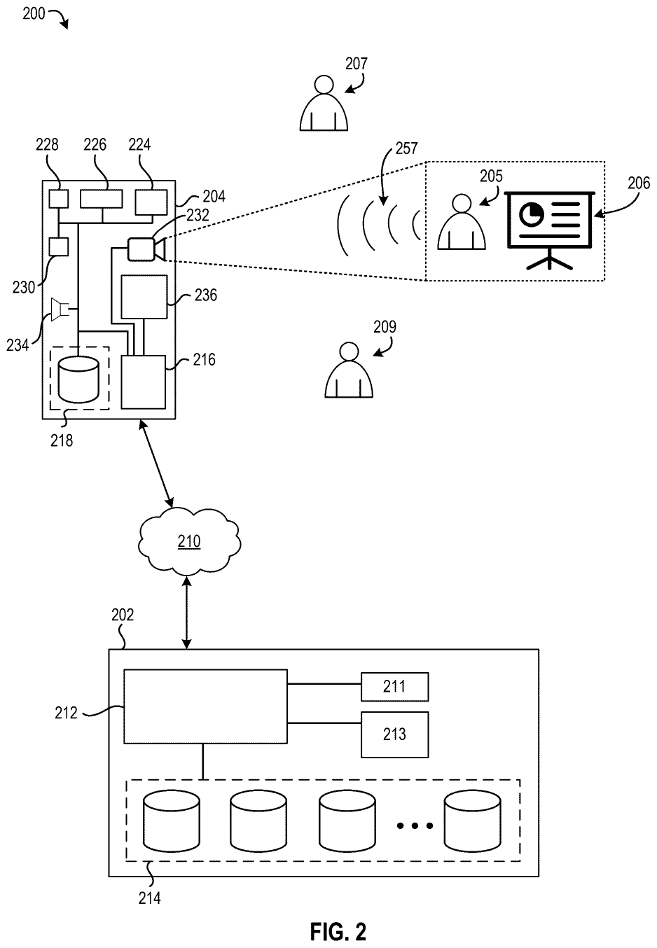

Looking now to FIG. 2, a system 200 configured to edit video (including images and audio) in real-time before being stored in memory is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a remote electronic device 204 that is accessible to (e.g., in the vicinity of) a presenter 205, along with live audience members 207, 209. Specifically, the central server 202 and the electronic device 204 are both connected to a network 210. The electronic device 204, presenter 205, and audience members 207, 209 may thereby be positioned at any location that is able to establish a connection to network 210. The electronic device 204 and central server 202 may also be separated from each other such that they are positioned in different geographical locations. Thus, approaches included herein may be utilized to conduct online presentations. For example, the remote electronic device 204 may be used to record a video that is then transmitted to one or more remote devices (e.g., using meeting based software such as ZOOM, WEBEX, TEAMS, etc.) such that virtual audience members (not shown) may be situated remotely.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. While the electronic device 204 and central server 202 are shown as being connected to network 210, two or more of the electronic devices may be connected differently depending on the approach. According to an example, which is in no way intended to limit the invention, two desktop computers may be located in the same office building and connected by a same wired network. In another example, which again is in no way intended to be limiting, edge compute nodes may be located relatively close to each other and connected by a wired connection, e.g., a cable, a fiber-optic link, a wire, etc.; etc., or any other type of connection which would be apparent to one skilled in the art after reading the present description.

With continued reference to FIG. 2, the electronic device 204 includes components that are configured to capture and edit video streams in real-time before storing the edited videos in memory. In other words, the electronic device 204 is able to capture a series of images of the presenter 205 along with content 206 using a camera 232. These images are further evaluated individually and in combination to determine whether the presenter 205 is performing any predetermined gestures in real-time. For example, each predetermined gesture may be correlated with respective video editing operation(s). Thus, in response to identifying the presenter 205 making one of the predetermined gestures, the video stream captured by camera 232 may be edited accordingly in real-time.

Moreover, only the edited video stream is actually stored in memory. The original (unedited) video stream is thereby captured by the camera 232, as well as evaluated and edited in real-time, before being stored in memory at all. As noted above, this allows for video data to be edited more efficiently and made available to a wide audience. For instance, specific content (e.g., confidential information) may be identified and removed from the incoming images, audio, etc., before it is actually stored in memory. This significantly reduces the chance of unwanted data exposure and increases operational efficiency of video capturing devices in general, e.g., as will be described in further detail below.

The electronic device 204 is also able to record audio signals 257 produced by the presenter 205. In some approaches, audio may be received from live audience members 207, 209 in a same environment as the electronic device 204 (e.g., within audio range of a microphone in camera 232, microphone 230, etc.) and included in the edited video stored in memory. While a number of audio signals may be received simultaneously at the electronic device in some approaches, processor 216 and/or artificial intelligence (AI) module 236 are preferably able to extract individual audio signals corresponding to individual ones of the live audience members 207, 209 and/or presenter 205. Additional audio processing may also be performed at the electronic device 204, e.g., such as noise filtering, volume boosting, etc.

AI based models may also be used to evaluate the images and/or audio signals that are received. For instance, the electronic device 204 includes an AI module 236 and processor 216 which may be used to train one or more AI based models to inspect images and/or audio signals that are received from presenter 205, and determine whether any predetermined gestures and/or sounds are made therein. The AI module 236 may include any desired number and/or type of AI based models, e.g., such as machine learning models, deep learning models, neural networks, etc. According to some approaches, the AI based models may include one or more classification models that have been trained using supervised learning. For example, the AI based models may be trained in a supervised manner using image and/or audio datasets that have been extracted from recorded phone calls and meetings.

In some approaches, AI module 236 may include one or more models that are trained using predetermined training set(s) of data. For example, in some approaches, one or more of the operations in method 300 below may be deployed in a trained state of an AI model. Training of the AI model, in some approaches, may be performed by applying a predetermined training data set to learn how to inspect images and/or audio signals that are received, and determine whether any predetermined gestures and/or sounds are made therein. Initial training may include reward feedback that may, in some approaches, be implemented using a subject matter expert (SME) that generally understands video editing, audio testing, image recognition, etc. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of approaches herein may be performed. In some further approaches, the AI model may be a neuromyotonic AI model that may improve performance of computer devices in an infrastructure associated with video editing, audio testing, image recognition, etc., because the neuromyotonic AI model may not need an SME and/or iteratively applied training with reward feedback in order to accurately perform operations described herein. Instead, the neuromyotonic AI model is configured to itself make determinations described in operations herein.

Weight values may, in some approaches, be used by the AI reasoning model to collect and analyze information and/or feedback potentially received in response to editing a video stream in real-time. Such an AI model ensures that re-training occurs, during which the accuracy with which the video stream is edited in real-time before being stored in memory is evaluated. Re-training may also be used to develop sets of customized gestures which correspond to specific presenters. As noted above, differences between customized gestures may result from physical limitations, ranges of motion, anatomy of the presenters themselves, etc. Thus, the re-training desirably allows for gestures to be customized and more gestures to be added for different edit actions, thus providing flexibility to the presenter.

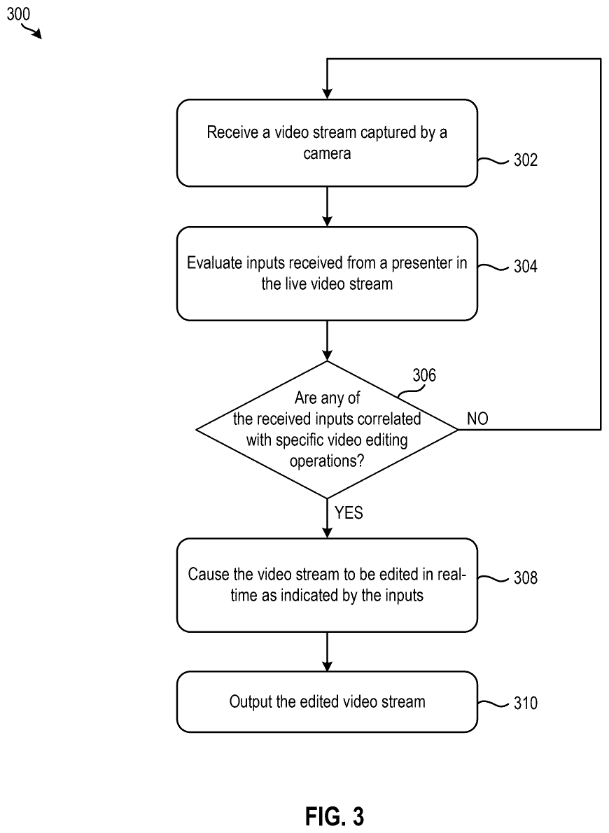

In situations where the accuracy of the edits decline, the data used to train the AI model(s) may be shifted (e.g., weighted) such that the AI model(s) produce more accurate edits to video streams as a result of the re-training, where the scale of such analysis and determinations would not otherwise be feasible for a human to perform. This is because humans are not able to efficiently perform complex re-training resulting from dynamic evaluation of modifications that are made to complex digital video streams before being stored in memory, and would otherwise incorporate processing delays and errors in the process of attempting to do so. Accordingly, management of operations described herein is not able to be achieved by human manual actions. Again, it follows that the processor 216 and/or AI module 236 in the electronic device 204 may perform any one or more of the operations described below in method 300 of FIG. 3 in order to improve the accuracy with which video streams are edited in real-time.

With continued reference to FIG. 2, the processor 216 is coupled to memory 218, which may include hard disk drives, solid state memory, optical memory drives, etc. depending on the approach. The processor 216 is also connected to an optional display screen 224, a physical user interface 226 (e.g., physical pushbutton array integrated in the exterior surface of the electronic device 204), a selector 228, a microphone 230, a camera 232, and an AI module 236. The processor 216 may thereby be configured to receive a variety of inputs through one or more of the microphone 230, the physical user interface 226, selector 228, and camera 232, e.g., as entered by the presenter 205 and/or live audience members 207, 209. Some of the inputs may correspond to information presented on the optional display screen 224 and/or emitted by speaker 234 while the entries were received. Moreover, the inputs received may impact the information emitted by speaker 234, data stored in memory 218, information collected from the microphone 230 and/or camera 232, status of an operating system being implemented by processor 216, etc.

The central data storage location 202 includes a large (e.g., robust) processor 212 coupled to a cache 211, an AI module 213, and a data storage array 214 having a relatively high storage capacity. The data storage array 214 may include any desired type of data storage components depending on the approach. Thus, while the data storage array 214 may be construed as illustrating hard disk drives, this is in no way intended to be limiting. In other approaches, the array 214 may include solid state drives having volatile and/or non-volatile memory therein, magnetic tape drives, optical storage drives, etc.

As described above with respect to AI module 236, AI module 213 may include any desired number and/or type of AI based models, e.g., such as machine learning models, deep learning models, neural networks, etc. AI module 213 may thereby be able to evaluate different characteristics of video streams that may be received from remote electronic device 204. For example, a live video stream may be received at central server 202 from remote electronic device 204 over network 210, and edited in real-time according to predetermined inputs (e.g., gestures, spoken words, etc., and/or combinations thereof) received from the presenter 205.

The central server 202 may also store at least some information about the electronic device 204, presenter 205, and/or live audience members 207, 209. For instance, user defined authentication information (e.g., password phrases), user-specific information (e.g., range of motion, age, medical conditions, accents, grammatical patterns, spoken language, volume profiles, cadence and/or inflection profiles, etc.), application preferences, performance metrics, etc., may be collected by the electronic device 204 from the presenter 205 over time. This collected information may be used to train (e.g., continually retrain) the one or more AI based models that are maintained at the AI module 213 and/or stored in memory (e.g., data storage array 214 and/or cache 211) for future use. Additionally, at least some of the information that is collected may be hashed and randomized before being stored in memory in some approaches. For instance, some approaches include encrypting and storing preferential selections, geographical location information, passwords, etc. This information can later be used to determine whether a particular gesture and/or audio signal corresponds to a genuine attempt to edit a video stream in real-time. For example, a presenter may be designated before a video stream begins, e.g., by interacting with a software interface used to establish and/or maintain the video stream. Edit actions (e.g., gestures) that are performed by the presenter may thereby be identified and considered genuine. This desirably removes any ambiguity regarding who is authorized to edit the captured, e.g., as will soon become apparent.

Looking now to FIG. 3, a flowchart of a computer-implemented method 300 for editing videos in real-time (e.g., before being stored to memory) based on inputs received from subjects in the videos, is illustrated in accordance with one approach. Approaches herein are thereby able to selectively edit videos as they are being recorded, avoiding any post processing or editing of the video after it has been stored in memory. This also allows for videos to be edited in (e.g., by) a same device that records the video, eliminating any additional third party editing software. Approaches are also able to provide an edited version of the video immediately following the live event (e.g., live video stream), thereby reducing latency as a whole, e.g., as will be described in further detail below. However, it should be noted that in other approaches, a video may be edited immediately after a presentation has concluded, e.g., as a form of immediate post processing. In such approaches, the edits are recorded while the video stream is being captured, but executed in direct response to the video stream ending. Gestures that are made by the presenter may be recorded along with when the gestures occurred by embedded the information in the video stream itself (e.g., using one or more types of encoding) and/or stored separately with some video context. However, final editing actions are preferably performed immediately after the video stream (e.g., presentation) has ended, as a form of immediate post processing. As noted above, because the edit gestures have already been recorded (e.g., been embedded in the captured video), it typically only takes approaches herein only a few milliseconds of post processing to edit the video.

The method 300 may be performed in accordance with the present invention in any of the environments depicted in FIGS. 1-2, among others, in various approaches. For instance, one or more operations in method 300 may be performed by components in the remote electronic device 204 and/or central server 202 of FIG. 2. Moreover, more or less operations than those specifically described in FIG. 3 may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. In preferred approaches, one or more of the operations in method 300 are performed by one or more processors, controllers, control units, etc., that are included in the camera capturing the videos being edited. While various operations in method 300 are thereby described in the context of a video stream being edited in real-time at the camera, the video stream may be transmitted elsewhere and edited in real-time before being stored in memory. In other approaches, the method 300 may be partially or entirely performed by a controller, a processor (e.g., see processor 212 and/or 216 of FIG. 2), one or more machine learning models (e.g., see machine learning module 213 and/or 236 of FIG. 2), etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, operation 302 of method 300 includes receiving a video stream captured by a camera. Operation 302 thereby includes receiving images of and/or audio from an environment surrounding the camera that are captured by the camera in real-time. In preferred approaches, the video stream includes images of at least a presenter and presentation material which corresponds to the statements, gestures, etc., being made by the presenter. As mentioned above, one or more of the operations in method 300 may be performed by a processor correlated with (e.g., physically inside, physically electrically coupled to, etc.) the camera that is capturing the video stream. Thus, the video stream may be “received” in operation 302 from image and/or audio sensors in the camera itself. However, in some approaches the live video stream is received from a remote location.

In response to receiving (e.g., capturing) the live video stream, method 300 advances to operation 304. There, operation 304 includes evaluating inputs received from a presenter in the live video stream. With respect to the present description, “inputs” may include any information that is provided by the presenter while the video is being created. In preferred approaches, operation 304 includes monitoring the movements (e.g., gestures) that are made by the presenter while the video is being recorded. In other approaches, operation 304 may include evaluating audio signals, visual inputs (e.g., flashing lights), logical inputs (e.g., selecting a logical button associated with the presentation), etc.

Operation 306 further includes determining whether any of the received inputs are correlated with specific video editing operations. As noted above, a list of inputs (e.g., gestures, statements, visual inputs, etc.) may be predetermined by the presenter, a system administrator, etc., as being correlated with specific video editing functions. According to a preferred approach, operation 306 includes determining whether any movements made by the presenter in the live video stream match one or more gestures that have been predetermined as indicating specific video editing steps are to be taken. In other words, approaches herein signify the use of specific edits to the video stream with gestures that effectively mark the portion(s) of the video stream that are to be edited, along with which editing steps are to be performed. For instance, presenters may make gestures to signify and ultimately cause desired edits to be made to the content being captured in real-time.

This is particularly desirable in comparison to the inefficiencies and limitations of conventional products. As mentioned above, conventional products are limited to inefficient options when editing video. According to a non-limiting example, conventional products are forced to save a presentation video to memory, load this video in a separate video editing software, run the video, bring the playback cursor to a start of the video being edited out, mark this as the start point of the edit out, bring the playback cursor to an end of the video being removed, mark this as the end point of the edit out, perform the edit out, save the remaining video back in memory, and send the edited video to original presenter. Also, because current products rely on manual editing being performed, there is a time lag between when the video is stored and when it is actually edited. Again, this is a time and resources intensive process that results in significant latency.

Approaches herein may identify specific (e.g., predetermined) gestures made by a presenter utilizing gesture recognition models (e.g., trained AI models, software, etc.) that is installed in the video recording device that is capturing a video stream. These gesture recognition models may evaluate each of the images captured to form the visual aspect of the video stream, e.g., using image recognition. As a result, a processor in the camera creating the video stream may identify and implement specific edits to the images and/or audio details being captured. Approaches herein also produce edited videos that are immediately available after the meeting ends, providing significant time savings.

In one example, which is in no way intended to be limiting, the gesture recognition models may identify specific hand and/or finger movements made by the presenter in real-time. These hand and/or finger gestures may be correlated with one or more specific video editing actions. Accordingly, these specific video editing actions may be applied directly to the images and/or audio signals being captured by the camera at that instant the gesture are recognized. Again, this allows for the corresponding editing action(s) to be executed on running video before the video is actually saved into a storage medium. Furthermore, when a live video stream ends, the saved final video is already edited as per the wishes of the speaker or presenter, recorded and recognized in the form of gestures.

According to one example, a gesture that may be correlated with a specific video editing action(s) includes the presenter raising three fingers together and waving them in the air. In this example, this gesture may be predetermined as representing a start point of confidential information being presented verbally and/or visually in presentation materials. A processor in the camera capturing the video stream that identifies this gesture of the presenter waving three extended fingers may thereby identify the confidential information and remove it from the video stream. In some approaches, this may include identifying key words in text displayed in presentation material, identifying text of any kind (e.g., in any language), using image recognition to identify specific shapes and/or objects, etc. In other approaches, this may include evaluating the words being spoken by a presenter and identifying key words to remove, removing any audio signals originating from live audience members, etc. In the example, the same gesture being repeated by the presenter (e.g., at least some predetermined amount of time after the initial gesture to avoid inadvertent repeats) may be predetermined as representing a stop point of confidential information being presented verbally and/or visually in presentation materials. Accordingly, the video stream may not be edited until another predetermined gesture (or input) is identified.

According to another example, a gesture that may be correlated with a specific video editing action(s) includes the presenter raising both hands and palms in parallel (e.g., as if creating two edges of a rectangle) and putting them in front of specific section of presentation material visual on a screen. In this example, this gesture may be predetermined as representing a section of the video stream that should be highlighted. A processor in the camera capturing the video stream that identifies this gesture of the presenter raising their hands in parallel may thereby identify the section to highlight, and add a spotlight to it. This may effectively cause the portion of the screen to be placed in focus, while dimming light on other portions of the screen and/or placing other portions of the screen out of focus. In the example, a different gesture of the presenter waving both their hands over their head may be predetermined as representing a stop point of the highlighted section of the video stream. Accordingly, the video stream may not be edited until another predetermined gesture (or input) is identified.

In another example, a gesture that may be correlated with a specific video editing action(s) includes the presenter extending their index finger and thumb in the shape of a half circle around a portion of the images captured by the camera. In this example, this gesture may be predetermined as representing a section of the video stream that displays confidential material which should be removed. A processor in the camera capturing the video stream that identifies this gesture of the presenter raising their hands to at least partially encircle a portion of the presentation material and/or a remainder of the image captured in the video stream, and removes the encircled content. This may effectively cause the encircled content to be blurred (e.g., placed out of focus), covered, cropped out, etc. In the example, the presenter removing their hands and/or fingers from encircling a portion of the presentation material may be predetermined as representing a stop point of the edited video stream. Accordingly, the video stream may not be edited until another predetermined gesture (or input) is identified.

In still another example, specific words spoken by the presenter during the video stream and captured by a microphone may be predetermined as edit actions. For instance, the presenter may audibly say the word “confidential” before verbally and/or visually presenting private (e.g., privileged) information. In response to detecting the speaker saying the word “confidential”, a processor in the camera capturing the video stream may thereby identify the confidential information and remove it from the video stream, e.g., using any of the approaches discussed herein.

As noted above, approaches herein are preferably able to capture images of, and audio from, a presenter; evaluate the movements and/or statements that are made by the presenter in real-time; identify predetermined feedback (e.g., gestures) in the captured images and/or audio signals; and edit the images and/or audio signals in a manner that is correlated with the predetermined feedback identified. Thus, referring still to FIG. 3, method 300 advances from operation 306 to operation 308 in response to determining that one or more of the inputs received from the presenter are predetermined as being correlated with specific video editing steps. However, method 300 is shown as returning to operation 302 in response to determining that the inputs received from the presenter are not predetermined as being correlated with specific video editing steps. Thus, the live video stream may continue to be received and evaluated in real-time to determine whether any other inputs received from the presenter are predetermined as being correlated with specific video editing steps. It follows that the evaluation step is preferably performed fast enough to not disrupt live video frame recording. In situations where the evaluation step is taking longer than desired, one or more of operations 302, 304, 306, 308, 310 may be performed by different threads running in parallel. Moreover, the operations of method 300 may be repeated in an iterative fashion while a video stream is being received.

Looking now to operation 308, there method 300 includes causing the video stream to be edited in real-time as indicated by the inputs. The video stream may thereby be edited differently depending on the inputs that are received from the presenter. For example, the video stream may be edited in real-time such that confidential information is selectively removed (e.g., blurred, covered, cropped out, etc.) from any presentation material in the images that are captured for the video stream. This may include blurring content presented on slides, cropping out portions of the images captured, adding an animated shape to existing image data, etc. In another example, the video stream may be edited in real-time such that a portion of the presenter is obstructed in the images that are captured. In one approach, a presenter's face, mouth, eyes, etc., may be blurred in, covered by animated (e.g., moving) shapes in, cropped out of, etc., the images that are taken. Furthermore, portions of one or more audio signals captured for the video stream which correspond to a period identified by predetermined inputs (e.g., gestures) received from the presenter may be modified. Depending on the approach, portions of audio signals may be removed, experience an adjustment in amplitude (e.g., audible volume), be overlayed with a bleep censor, etc.

Operation 308 also preferably includes editing a portion of the video stream and/or presentation material included therein that corresponds to (e.g., coincides with) when the presenter made a predetermined input (e.g., gesture). For example, a portion of the video stream that begins at a same time that the presenter gestures a start point and ends at a same time that the presenter gestures an end point, may be modified in a manner that corresponds to the specific start and/or stop point gestures. In other approaches, some gestures may be predetermined as corresponding to a time offset. For example, a portion of the video stream beginning 5 seconds after the presenter gestures a delayed start point and ending 5 seconds after the presenter gestures a delayed end point, may be modified in a manner that corresponds to the specific start gestures. In such approaches, a running time recorded along with the video may be used to identify the start and stop edit points with precision.

It should also be noted that the video stream is edited before being stored in memory. In other words, the images and/or audio signals that are captured by a camera are not actually stored in memory (e.g., non-transitory memory) until after they have been edited according to any predetermined inputs that are received. As noted above, in some approaches, a processor included in the camera creating a video stream may be used to locally evaluate and edit images and/or audio signals that are captured by the camera in real-time. Only the edited video stream may thereby be output and ultimately stored in memory. As noted above, this is particularly desirable in situations involving confidential information disclosed by a presenter and recorded in a video stream. For instance, the presenter may make a first predetermined gesture to signify the start of the confidential information, and a second predetermined gesture to signify the end of the confidential information. As a result, one or more processors in the camera creating the video stream may remove content (e.g., presentation material) from the captured images and/or portions of the recorded audio signals for a time span that corresponds to the presenter making the first and second predetermined gestures.

As mentioned, some approaches develop, and train AI based models to identify a presenter making predetermined gestures in video streams. These trained AI based models may thereby be used to determine when specific edits should be made to the images and/or audio recordings. The AI based models may also be used to evaluate the gestures that are made by a presenter, and determine whether any are predetermined as corresponding to specific video editing steps. The AI based models may thereby be trained to recognize patterns in body language, anatomic details, physical limitations, etc., and how those patterns pertain to gestures that are made in real-time.

For example, the AI based models may be trained to identify genuine attempts at signifying specific edits should be made to the video being created. In some approaches, intentional gestures may be distinguished from normal body language by the emphasis placed on the intentional gestures. The presenter may animate the intentional gestures by raising their arms past a specific height, holding a specific portion of the gesture for a predetermined amount of time, accompanying a gesture with a specific audible signal, etc.

It follows that the AI based models are trained to detect genuine attempts to indicate edits should be made to a video stream in real-time, and differentiate the genuine attempts from inadvertent activations. Moreover, by continuing to train (e.g., retrain) the AI based models based on performance experienced over time, the efficiency at which genuine attempts to signify edits for the video stream are identified may further be increased, e.g., as will be described in further detail below.

With continued reference to FIG. 3, method 300 advances from operation 308 to operation 310 in response to the video stream being edited in real-time as indicated by the received inputs (e.g., gestures). There, operation 310 includes outputting the edited video stream. In some approaches, operation 310 is performed in response to the video stream ending and the edited video stream being completed. In other approaches, the edited video stream may be output dynamically as the original video stream is received and edited in real-time. In preferred approaches, the edited video stream is output and stored in memory. Accordingly, operation 310 may include storing the edited video stream in non-transitory memory. In some approaches, operation 310 may include storing the edited video stream at least temporarily in transitory memory. As noted above, by intentionally not storing the video stream until after it has been edited (e.g., modified) as indicated by the presenter using inputs (e.g., gestures), approaches herein desirably avoid confidential information and/or other sensitive details from being exposed.

In other approaches, operation 310 includes sending the edited video stream to one or more remote locations, e.g., using a network. Again, only the information that is still available in the edited video stream may be accessible to the remote locations. This feature may be used to protect sensitive information, foster a feeling of exclusivity for the live audience members, etc.

It follows that one or more of the operations in method 300 are desirably able to edit videos in real-time (e.g., before being stored to memory) based on inputs received from subjects (e.g., the presenters) in the videos. Approaches herein are thereby able to selectively edit videos as they are being recorded, thereby avoiding any post processing or editing of the video after it has been stored in memory. This also allows for videos to be edited in (e.g., by) a same device that records the video, eliminating any potential exposure of confidential information. Approaches are also able to provide an edited version of the video immediately following the live event, thereby reducing latency as a whole.

Again, the operations of method 300 are preferably performed by a processor in the camera (e.g., physically connected to the camera, positioned within the sidewalls of the camera, etc.) that is capturing the video stream being edited. In other words, the gesture recognition models described herein are running in video capturing device itself in some approaches. As noted above, these models are preferably trained to recognize predetermined gestures and correlate the identified gestures to specific editing steps performed on the running video in real-time as it is being created, as per the presenter's intent identified through the gestures.

It should be noted that although approaches herein are described in the context of identifying gestures made by an individual captured in the video stream, other inputs may be considered while editing the video stream. For example, recorded audio inputs, visual inputs (e.g., flashing light), etc., may be identified and used to determine how content in the video stream should be edited. For example, one or more AI based models may be trained to interpret gestures that are accompanied by a predetermined vocal cue, e.g., in order to avoid any inadvertent edits being made to the video stream.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. (canceled)

2. The method of claim 5, wherein the video stream includes images of the presenter and presentation material.

3. The method of claim 5, further comprising:
in response to the video stream ending, outputting the edited video stream,
wherein the outputting the edited video stream includes storing the edited video stream in non-transitory memory.

4. The method of claim 5, wherein the video stream is a live video stream.

5. A method comprising:
receiving a video stream captured by a camera, the video stream including images of a presenter and presentation material;
monitoring movements of the presenter in the video stream; and
in response to detecting the presenter making a predetermined gesture, causing the video stream to be edited in real-time such that a portion of the presentation material which corresponds to when the presenter made the predetermined gesture is modified in a manner that is correlated with the predetermined gesture,
wherein the causing the video stream to be edited in real-time such that a portion of the presentation material which corresponds to when the presenter made the predetermined gesture is modified in a manner that is correlated with the predetermined gesture includes:
removing confidential information from the presentation material in the images.

6. The method of claim 5, wherein the causing the video stream to be edited in real-time such that a portion of the presentation material which corresponds to when the presenter made the predetermined gesture is modified in a manner that is correlated with the predetermined gesture includes:
highlighting a portion of the presentation material in the images.

7. The method of claim 5, wherein the operations are performed by a processor in the camera.

8. A computer program product comprising:
one or more computer-readable storage media; and
program instructions stored on the one or more storage media to perform operations comprising:
receiving a video stream captured by a camera, the video stream including images of a presenter and presentation material;
monitoring movements of the presenter in the video stream; and
in response to detecting the presenter making a predetermined gesture, causing the video stream to be edited in real-time such that a portion of the presentation material which corresponds to when the presenter made the predetermined gesture is modified in a manner that is correlated with the predetermined gesture,
wherein the causing the video stream to be edited in real-time such that a portion of the presentation material which corresponds to when the presenter made the predetermined gesture is modified in a manner that is correlated with the predetermined gesture includes:
highlighting a portion of the presentation material.

9. The computer program product of claim 8, wherein the video stream includes images of the presenter and presentation material, wherein highlighting a portion of the presentation material includes:
causing sections of the respective images in the video stream which correspond to the portion of the presentation material to be brightened and kept in focus; and
intentionally causing a remainder of the respective images in the video stream to be dimmed and kept out of focus.

10. The computer program product of claim 8, wherein the operations further comprise:
in response to the video stream ending, outputting the edited video stream,
wherein the outputting the edited video stream includes storing the edited video stream in non-transitory memory.

11. The computer program product of claim 8, wherein the video stream is a live video stream.

12. The computer program product of claim 8, wherein the causing the video stream to be edited in real-time such that a portion of the presentation material which corresponds to when the presenter made the predetermined gesture is modified in a manner that is correlated with the predetermined gesture includes:
removing confidential information from the presentation material in the images.

13. The computer program product of claim 8, wherein the causing the video stream to be edited in real-time such that a portion of the presentation material which corresponds to when the presenter made the predetermined gesture is modified in a manner that is correlated with the predetermined gesture includes:
highlighting a portion of the presentation material in the images.

14. The computer program product of claim 8, wherein the operations are performed by a processor in the camera.

15. A computer system comprising:
a processor set;
one or more computer-readable storage media; and
program instructions stored on the one or more storage media to cause the processor set to perform operations comprising:
receiving a video stream captured by a camera, the video stream including images of a presenter and presentation material;
monitoring movements of, and words articulated by, the presenter in the video stream in real-time;
in response to detecting the presenter making a predetermined gesture, causing the video stream to be edited in real-time such that a portion of the presentation material which corresponds to when the presenter made the predetermined gesture is modified in a manner that is correlated with the predetermined gesture; and
in response to detecting the presenter articulating one or more key words, muting a portion of an audio signal correlated with the images of the presenter and presentation material in the video stream, wherein the muted portion of the audio signal corresponds to when the presenter articulated the one or more key words.

16. The computer system of claim 15, wherein the video stream includes images of the presenter and presentation material.

17. The computer system of claim 15, wherein the operations further comprise:
in response to the video stream ending, outputting the edited video stream,
wherein the outputting the edited video stream includes storing the edited video stream in non-transitory memory.

18. The computer system of claim 15, wherein the video stream is a live video stream.

19. The computer system of claim 15, wherein the causing the video stream to be edited in real-time such that a portion of the presentation material which corresponds to when the presenter made the predetermined gesture is modified in a manner that is correlated with the predetermined gesture includes:
removing confidential information from the presentation material in the images.

20. The computer system of claim 15, wherein the causing the video stream to be edited in real-time such that a portion of the presentation material which corresponds to when the presenter made the predetermined gesture is modified in a manner that is correlated with the predetermined gesture includes:
highlighting a portion of the presentation material in the images.

21. The method of claim 5, wherein removing confidential information from the presentation material in the images includes:
identifying text of any kind in the images of the presentation material;
determining whether any of the identified text includes one or more key words; and
in response to determining at least some of the identified text includes one or more key words, obscuring the at least some of the identified text that includes the one or more key words.
